(19) United States
(12) Patent Application Publication
(10) Pub. No.: US 2026/0200191 A1
(43) Pub. Date: Jul. 16, 2026

(54) METHOD FOR RESTORING A MONITORING FUNCTIONALITY IN A TYRE AND RELATIVE TYRE

(71) Applicant: Pirelli Tyre S.p.A., Milano (IT)

(72) Inventors: Corrado ROCCA, Milano (IT); Andrea NATTA, Milano (IT)

(73) Assignee: Pirelli Tyre S.p.A., Milano (IT)

(21) Appl. No.: 19/136,680

(22) PCT Filed: Dec. 19, 2023
(86) PCT No.: PCT/IT2023/050288

§ 371 Date: Jun. 6, 2025

(30) Foreign Application Priority Data
Dec. 22, 2022 (IT) 102022000026478

(51) Int. Cl. B29D 30/00; B60C 19/00

(52) U.S. Cl. CPC B29D 30/0061; B60C 19/00; B29D 2030/0083; B60C 2019/004

(57) ABSTRACT

Method of restoring a monitoring functionality in a tyre (99) and tyre (99) suitable for such method for restoring, the method comprising producing the vulcanized tyre (99) comprising at least a first (A1) and a second clean portions (A2) of an inner surface (1) of the tyre (99), fixing a first monitoring device (3) on the first clean portion (A1) and leaving the second clean portion (A2) free of monitoring devices; and, following a loss of monitoring functionality by the first monitoring device (3) fixed onto the first clean portion (A1) , fixing a second monitoring device (4) onto the second clean portion (A2).

### TECHNICAL FIELD OF THE INVENTION

The present invention relates to a method for restoring a monitoring functionality in a tyre, and a tyre suitable for implementing such method.

### STATE OF THE ART

Typically, a tyre has a substantially toroidal structure around an axis of rotation thereof during operation, and has an equatorial plane perpendicular to the axis of rotation, said equatorial plane typically being a plane of (substantial) geometric symmetry (e.g. neglecting any minor asymmetries, such as the tread design and/or the writing on the sidewalls and/or the inner structure).

By “crown portion” it is meant the portion of tyre located at the tread band.

The terms “radial” and “axial” are used to refer respectively to a direction perpendicular and to a direction parallel to the axis of rotation of the tyre.

The term “tangential” is used to refer to a direction generally facing the rolling direction of the tyre, perpendicular to both the radial direction and the axial direction.

There are known tyres comprising a monitoring device fixed to the inner surface of the tyre at the crown portion to implement a monitoring functionality of one or more physical quantities relating to the tyre, such as for example temperature, pressure, acceleration of the inner surface, deformation of the inner surface, etc.

### SUMMARY OF THE INVENTION

In the context of the manufacturing of tyres comprising a monitoring device, the manufacturing process typically comprises, in the order, building the green tyre, vulcanizing the tyre, and fixing the monitoring device to the inner surface of the vulcanized tyre.

Before proceeding with fixing the monitoring device, the portion of the inner surface at the point where the device has to be fixed is typically treated or protected, so that it results substantially free of contaminating agents residual from the vulcanization (such as silicone release agents used on the vulcanization chamber and/or on the green tyre). These contaminants can in fact affect the stable and long-lasting adhesion of the monitoring device to the inner surface of the tyre.

Subsequently to the fixing of the monitoring device, for example after the tyre has been marketed, some situations may arise which can preclude the correct functioning of the monitoring device. For example, it may happen that the monitoring device is physically damaged, for example by mechanical impact, during the mounting of the tyre on the rim, or that, following the use of the tyre, the monitoring device incurs into failure, malfunction and/or or detachment, for example due to the high accelerations to which it is subjected during use, or that it stops working due to the exhaustion of the respective electric power supplier.

In these cases, for restoring the monitoring functionality, the no longer functioning monitoring device must be replaced, by removing the device itself and the means used for the fixing it (protective casings made of rubber or other materials, glues, etc.) and by rigorous cleaning of the inner surface of the tyre for fixing a new monitoring device.

Furthermore, since these events that make the monitoring device non-functional can occur after the tyre has been marketed, it follows that the restoration of the monitoring functionality is mostly entrusted to external operators, who are not always adequately equipped or trained for performing such removal, rigorous cleaning and replacement operations. In particular, a poorly performed removal and/or cleaning operation can lead to an unstable fixing of the new monitoring device, or even to damage of the inner surface of the tyre (for example the inner liner, with possible loss of the desired airtightness of the tyre itself). In particularly serious cases, the whole tyre may also be replaced.

The Applicant has therefore faced the problem of restoring a monitoring functionality in a tyre through a reliable and at the same time simple, rapid, economical procedure, which does not necessarily require the use of specialized personnel or dedicated equipment, nor the replacement of the whole tyre.

The Applicant has found that the aforementioned problem can be solved by making the tyre, downstream of the vulcanization, to be provided with at least two clean portions, one of which is used for fixing a first monitoring device, and the other is used only subsequently, if necessary, for fixing a further monitoring device distinct from the first. The Applicant has in fact surprisingly discovered that the additional clean portion realized at new tyre lends itself to being used (possibly after even just a brief cleaning) for fixing a respective monitoring device at times well after the production of the tyre, for example even months later, for example after the tyre has been marketed and/or stored and/or used.

Therefore, according to a first aspect the present invention relates to a method for restoring a monitoring functionality in a tyre. The method comprises:
producing a vulcanized tyre comprising (at least) a first and a second clean portion of an inner surface of said tyre;
fixing a first monitoring device onto said first clean portion and leaving said second clean portion free of monitoring devices; and
following a loss of monitoring functionality by said first monitoring device fixed onto said first clean portion, fixing a second monitoring device onto said second clean portion.

By “clean portion” it is defined a portion of the inner surface of the vulcanized tyre substantially free of contaminating agents (e.g. silicone release agents) residual from the vulcanization of said tyre.

As mentioned above, the Applicant has surprisingly discovered that, contrary to what was expected, the additional clean portion made within new tyre, i.e. the aforementioned second clean portion (distinct from the first clean portion), lends itself to being used for fixing a respective monitoring device also at times subsequent to the production of the tyre, for example even months later, for example after the tyre has been marketed and/or stored and/or used. The Applicant has in fact verified that during this time period and/or these events, the second clean portion typically undergoes soiling, but of a qualitatively less serious degree (for the purposes of effective cleaning for fixing the new monitoring device) with respect to the remaining portions of inner surface of the tyre on which the residues of the contaminating agents used during vulcanization remain.

The Applicant has also verified that a new, functioning, monitoring device can be applied to the additional clean portion, even after months of use and/or storage of the tyre, without the need for specialized personnel, hard-to-find cleaning materials and/or special machinery (e.g. laser cleaning systems, etc.).

In a second aspect, the present invention relates to a vulcanized tyre comprising (at least) a first and a second clean portion of an inner surface of said tyre, wherein said tyre comprises a first monitoring device fixed on said first clean portion, and wherein said second clean portion is free of monitoring devices.

The present invention, in one or more of its aspects, may exhibit one or more of the following preferred features.

Preferably said first clean portion is spatially separated from said second clean portion.

Preferably said first and/or second clean portion are made at a crown portion of said tyre. In this way the fixing of the respective monitoring device is facilitated.

Preferably said tyre comprises a plurality of clean portions, including said first and second clean portion (e.g. the tyre comprises a third clean portion free of monitoring devices), wherein said clean portions of said plurality are more preferably (substantially) angularly uniformly distributed (with respect to an axis of rotation of said tyre) along the inner surface of the tyre. In this way, in case the clean portions are all simultaneously occupied by a respective monitoring device, the arrangement of the masses of such monitoring devices is balanced with respect to the rotation of the tyre.

Preferably said method comprises, subsequently to said fixing said second monitoring device, keeping said first monitoring device fixed onto said first clean portion. In other words, the first monitoring device may not even be removed. In this way it is possible to save time and/or operations to be performed on the inner surface of the tyre, also reducing the risk of damaging the tyre.

In one embodiment said method comprises making said first and/or second clean portion by laser abrasion of said inner surface performed downstream of a vulcanization of said tyre (before fixing said first monitoring device). The Applicant has observed that the laser effectively removes the residues of the release agents.

Preferably said method comprising marking, on said inner surface, more preferably at said first and/or second clean portion, a (graphic) sign representative of an intersection between said inner surface and an equatorial plane of said tyre, more preferably by laser writing, even more preferably contextually (e.g. simultaneously or immediately after) with said making said first and/or second clean portion by laser abrasion. In this way, a reference is also advantageously provided for fixing the monitoring devices which need to be fixed to the inner surface with a given spatial relationship with the equatorial plane of the tyre.

In one embodiment, for the purpose of making said first and/or second clean portion, said method comprises the following steps:
producing a green tyre;
applying a first and/or a second protective patch (e.g. film made of nylon and/or polyester and/or poly-4-methyl-1-pentene, for example multilayered, rubber, teflon, Mylar™ polyester, polyurethane, polyolefins, such as for example polyethylene and/or polypropylene, etc.) at a respective first and/or second portion of inner surface precursor respectively of said first and/or second clean portion;
vulcanizing said green tyre; and
removing said first and/or second protective patch from the vulcanized tyre.

In this way the creation of the first and/or second clean portion is simple and/or cheap.

Preferably the fixing of said second monitoring device is performed subsequently to a commercialization of said tyre, more preferably subsequently to a use of said tyre in a wheel of a vehicle and/or a storage of said tyre for a time period (e.g. greater than three/six months). The second clean portion can in fact be used at any time after the tyre production.

Preferably said method comprises, before fixing said second monitoring device, cleaning said second clean portion with a detergent, more preferably only manually. In this way the restoration is particularly simple, quick and cheap. The Applicant has verified that a simple cleaning (even manual) with normal detergent of the second clean portion is sufficient to bring it back to a clean state suitable for fixing the monitoring device (i.e. as if it had just been made at new tyre).

Preferably cleaning with said detergent is performed using a solvent, for example a hydrocarbon-based solvent (such as for example a solvent for contaminants and/or release agents, e.g. silicone release agents, and/or a solvent comprising, or based on, limonene). For example, the hydrocarbon-based solvent can be the Liquid Buffer™ tyre solvent produced by Rema Tip Top AG or the Rub-O-Matic tyre solvent produced by Tech Tire Repair Supplies & Equipment). The Applicant has found this type of solvents to be advantageous for cleaning the second clean portion.

In one embodiment, cleaning with said detergent is performed using a ketone solvent, such as acetone, methyl-ethyl-ketone (MEK), etc.

In one embodiment, cleaning with said detergent is performed using an alcohol-based solvent, more preferably denatured alcohol.

In one embodiment, cleaning with said detergent is performed using one or more of the aforementioned solvents.

For example, the solvent can be in liquid form or in aerosol form.

Preferably said first and/or second monitoring device comprises an electronic unit.

Preferably said electronic unit comprises at least one sensor for detecting at least one of the following physical quantities: temperature, pressure, acceleration, deformation; a processing unit; a transceiver.

Preferably said at least one sensor is suitable for detecting at least two of the following physical quantities: temperature, pressure, acceleration, deformation, for example temperature and pressure. Even more preferably, said at least one sensor is suitable for detecting at least three of, or even all four, said physical quantities. Preferably said at least one sensor is suitable for detecting said acceleration, more preferably at least one component (axial, radial and/or tangential) of said acceleration. In this way the monitoring device provides particularly useful data for obtaining the state and/or the functioning of the tyre, and/or the behaviour of the vehicle on which it is mounted.

Preferably said first and/or second monitoring device comprises an electric power supplier electrically connected to said electronic unit.

By ‘electric power supplier’ it is meant a component structured to supply electric power, whether the power supplied is pre-accumulated (as in accumulators, e.g. batteries or capacitors) or whether the power supplied is generated and/or received in situ in real time (such as in energy recovery devices, or ‘energy harvesting’, combined or not with energy accumulators).

Typically said electric power supplier is an electric power accumulator, more preferably comprising a battery, for example a button battery.

### BRIEF DESCRIPTION OF THE FIGURES

FIG. 1 schematically shows a section of a tyre according to a first embodiment of the present invention;

FIG. 2 schematically shows a section of a tyre according to a second embodiment of the present invention;

FIGS. 3 and 4 schematically show a respective perspective view of a detail of a tyre according to the present invention.

### DETAILED DESCRIPTION OF SOME EMBODIMENTS OF THE INVENTION

The features and advantages of the present invention will be further apparent from the following detailed description of some embodiments, presented by way of example and not as a limitation of the present invention, with reference to the attached figures.

In a first aspect, the present invention relates to a method for restoring a monitoring functionality in a tyre 99.

The method comprises producing a vulcanized tyre 99 comprising at least a first A1 and a second clean portion A2 of an inner surface 1 of the tyre 99.

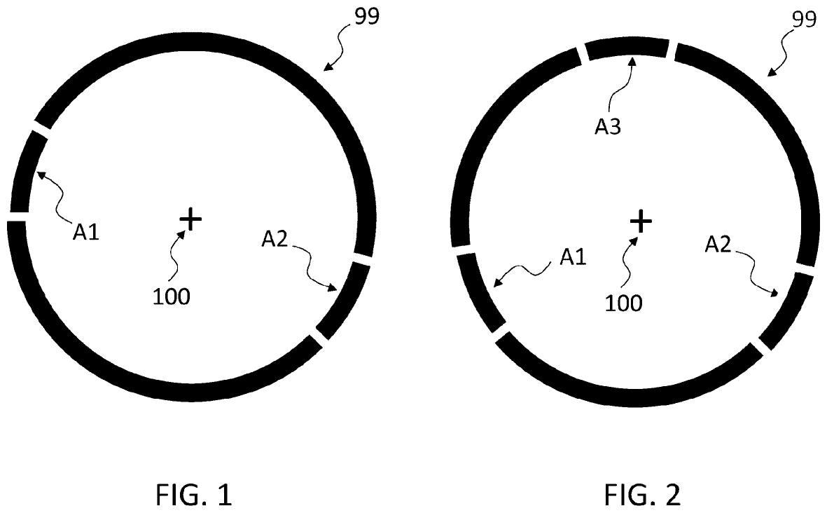

Exemplarily, in the embodiment of FIG. 1, the tyre 99 comprises only the two aforementioned clean portions A1 and A2, while in the embodiment of FIG. 2, the tyre 99 exemplarily also comprises a third clean portion A3.

In particular, the present invention can provide any number (greater than or equal to two) of clean portions of the inner surface 1 of the tyre 99.

Exemplarily, each clean portion A1, A2 and A3 is made at a crown portion 2 of the tyre 99, wherein the clean portions are spatially separated from each other.

In a not shown embodiment, the first and the second clean portion (and possibly also the third clean portion) can be distinct from each other and spatially contiguous, provided that sufficient space is provided for fixing two distinct monitoring devices.

Exemplarily, the clean portions A1, A2 and A3 are substantially angularly uniformly distributed, with respect to an axis of rotation 100 (indicated by the symbol + in FIGS. 1 and 2) of the tyre 99, along the inner surface 1 of the tyre 99. In particular, in the embodiment of FIG. 1, the first A1 and the second clean portion A2 are exemplarily arranged diametrically opposite to each other, while in the embodiment of FIG. 2, the three clean portions A1, A2 and A3 are arranged with a mutual angle of (approximately) 120°.

In one embodiment, the method comprises making one or more of (advantageously all) the clean portions A1, A2 and A3 (according to the embodiment) by laser abrasion of the inner surface 1 performed downstream of the vulcanization of the tyre 99.

Exemplarily, for performing the cleaning by laser abrasion, known laser cleaning systems can be used, such as those marketed by the company 4JET Technologies GmbH and/or the company SLCR Lasertechnik GmbH.

In one embodiment, the method can further comprise marking, on the inner surface 1, at one or more of the clean portions, a graphic sign (not shown) representative of an intersection between the inner surface 1 and an equatorial plane (not shown) of the tyre, for example by laser writing and advantageously contextually (e.g. simultaneously or immediately after) with making the clean portions by the aforementioned laser abrasion.

In another embodiment, for the purposes of making one or more of (advantageously all) the clean portions A1, A2 and A3 (according to the embodiment), the method may exemplary comprise applying, on a green tyre (precursor of the vulcanized tyre 99), a protective patch (e.g. film made of nylon and/or polyester, and/or poly-4-methyl-1-pentene, for example multilayered, rubber, teflon, Mylar™ polyester, polyurethane, polyolefins, such as for example polyethylene and/or polypropylene, etc.) at a respective portion of the inner surface 1 precursor of a respective clean portion (i.e. a protective film is applied for each clean portion to be made, the surface extension of the protective film substantially corresponding to the surface extension of the respective clean portion downstream of the vulcanization). It is therefore exemplarily provided vulcanizing the green tyre with the protective patches applied to the inner surface, and then removing each protective patch from the vulcanized tyre.

Downstream to making the clean portions (regardless of the adopted making methodology), the method therefore comprises fixing—for example by gluing—a first monitoring device 3 on the first clean portion A1 and leaving the second clean portion A2 (and possibly any other clean portion present, such as the clean portion A3 of the tyre of FIG. 2) free of monitoring devices.

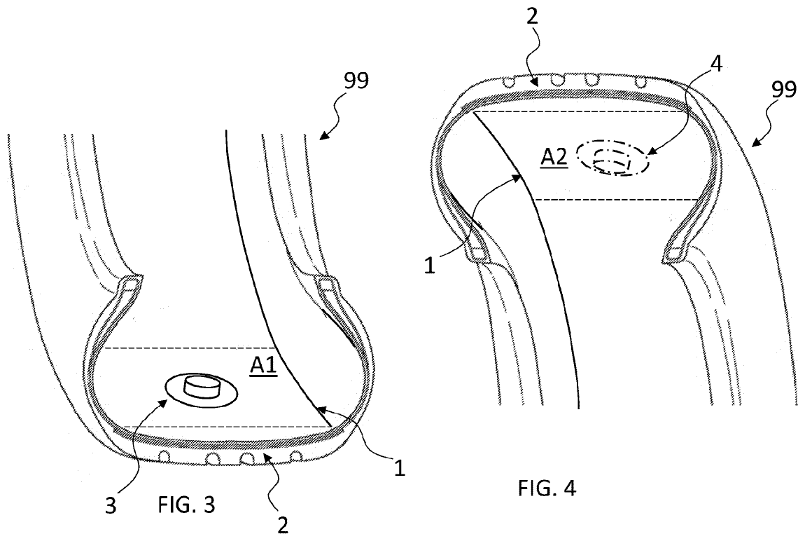

Exemplarily, the first monitoring device 3 comprises an electronic unit (not shown) in turn comprising at least one sensor (not shown) for detecting at least one of (preferably all) the following physical quantities: temperature, pressure, acceleration, deformation; a processing unit (not shown); a transceiver (not shown). Exemplarily, the first monitoring device also comprises an electric power supplier (not shown, e.g. a button battery) electrically connected to said electronic unit. Exemplarily, as shown in FIGS. 3 and 4, the first monitoring device 3 can comprise an enlarged surface portion suitable for durable fixing onto the inner surface 1 of the tyre 99. Exemplarily, this surface can be made using a patch of elastomeric material (possibly reinforced with textile or metal cords), as described for example in patent application WO 2018/065846 in the name of the same Applicant, or by an enlarged base portion of an encapsulation material used to protect the electronic unit and/or the electric power supplier, as described for example in patent application WO 2019/123118 in the name of the same Applicant.

Exemplarily, the tyre 99 is therefore equipped with a monitoring functionality implemented thanks to the first monitoring device 3. The tyre 99 thus obtained is exemplarily shown in FIGS. 1-4. For the purposes of greater clarity, it is noted that FIGS. 3 and 4 can equivalently refer to the tyre 99 belonging both to the embodiment of FIG. 1 and to the embodiment of FIG. 2.

The method for restoration further comprises, following a loss of monitoring functionality by the first monitoring device 3 fixed onto the first clean portion A1, fixing—for example by gluing—a second monitoring device 4 (shown with dotted line in FIG. 4) onto the second clean portion A2.

In the embodiment of FIG. 2, the third clean portion A3 can be used alternatively to the second clean portion A2, i.e. for accommodating the second monitoring device 4 following loss of monitoring functionality of the first monitoring device 3, or, subsequently, in addition to the second portion clean A2, i.e. for example for accommodating a third monitoring device (not shown) following loss of monitoring functionality (also) of the second monitoring device.

For example, the second monitoring device 4 (and possibly also the third monitoring device) are similar, e.g. for what concerns monitoring functionality and/or structure, to the first monitoring device 3 as briefly described above.

The aforementioned loss of monitoring functionality of the first monitoring device 3 can derive from one or more of the following events referred to the first monitoring device 3: damage, detachment (from the inner surface 1), electric/electronic failure, exhaustion of a respective electric power supplier. In other words, the method for restoring provides for the application of the second monitoring device when the first monitoring device 3 is no longer capable of performing one or more of its monitoring functions.

Typically, the aforementioned events from which the loss of monitoring functionality can derive also occur long after (e.g. even few months after) the marketing of the tyre 99 equipped with the first monitoring device 3. In fact, exemplarily, the application of the second monitoring device 4 can be performed after the marketing of the tyre 99, subsequently to a use of the tyre 99 in a vehicle wheel and/or a storage of the tyre for a time period (e.g. greater than three/six months). The second clean portion A2 (or equivalently the third clean portion A3 in the embodiment of FIG. 2) can in fact be used at any time after the production of the tyre 99.

Incidentally, the Applicant has realized that the method for restoring according to the present invention can also be advantageously used in production phase of the vulcanized tyre 99 comprising the first monitoring device 3. In fact, after having been physically fixed to the tyre, the first monitoring device 3 can also be associated at IT level (e.g. software) to the tyre, in a coupling operation (also called “pairing”) in which the serial identification number of the first monitoring device 3 is uniquely associated to the serial identification number of the tyre, so that to each tyre corresponds one and only one respective monitoring device (for purposes dictated by the subsequent use on the vehicle).

The Applicant has found that, during the aforementioned pairing operation, an error, e.g. at a software level, can sometimes occur such as to preclude the positive outcome of the operation. In this circumstance it is not possible to repeat the pairing operation with the same monitoring device, which must therefore be replaced. In particularly serious cases it may happen that both the monitoring device and the respective tyre must be discarded.

In the aforementioned circumstance, i.e. in the event of a failure of the pairing operation of the first monitoring device 3, the second clean portion A2 (or equivalently the third clean portion A3 in the embodiment of FIG. 2), thanks to the method for restoring according to the present invention can be immediately used for accommodating the second monitoring device 4, allowing the production of the tyre equipped with monitoring device to be completed.

Exemplarily, the method comprises, subsequently to fixing the second monitoring device 4, keeping the first monitoring device 3 fixed onto the first clean portion A1. In other words, the first monitoring device 3 may not even be removed from the inner surface 1 of the tyre 99.

Exemplarily, the method comprises, before fixing the second monitoring device 4, cleaning the second clean portion A2 (or equivalently the third clean portion A3) with a detergent, for example even only manually (e.g. using a cloth and/or paper).

In one embodiment, the detergent used is advantageously a solvent, for example a hydrocarbon-based solvent (such as for example a solvent for contaminants and/or release agents, e.g. silicone release agents, and/or a solvent comprising, or based on, limonene). For example, the hydrocarbon-based solvent can be the Liquid Buffer™ tyre solvent produced by Rema Tip Top AG or the Rub-O-Matic tyre solvent produced by Tech Tire Repair Supplies & Equipment).

Another type of usable solvents may comprise ketone solvents, such as acetone, methyl-ethyl-ketone (MEK), etc.

In one embodiment the detergent can be an alcohol-based solvent, preferably denatured alcohol.

For example, the solvent can be in liquid or aerosol form.

Optionally, several simple cleaning phases with detergent can also be provided, possibly also combining cleaning with one or more of the above-mentioned solvents.

Possibly, in case of presence of the third clean portion A3 and loss of monitoring functionality also of the second monitoring device 4 (even long after the loss of functionality of the first monitoring device 3, for example after further use and/or storage of the tyre 99), the method for restoring can exemplarily comprise repeating the aforementioned phases referred to the second monitoring device 4 and/or to the second clean portion A2 (or to the third clean portion A3 if used as an alternative to the second clean portion A2), also for the third monitoring device and/or for the third clean portion A3 (or for the second clean portion A2 if the third clean portion A3 had already been used in its place).

What has just been described in case of three clean portions also applies in case of further clean portions of the inner surface 1 in addition to the third, each intended to accommodate a respective monitoring device in the event of loss of functionality of the monitoring devices previously fixed onto the inner surface.

1-10. (canceled)

11. A method for restoring a monitoring functionality in a tyre, the method comprising:
producing a vulcanized tyre comprising at least a first and a second clean portion of an inner surface of the tyre;
fixing a first monitoring device onto the first clean portion and leaving the second clean portion free of monitoring devices; and
following a loss of monitoring functionality by the first monitoring device fixed onto the first clean portion, fixing a second monitoring device onto the second clean portion.

12. The method according to claim 11, comprising, subsequently to the fixing the second monitoring device, keeping the first monitoring device fixed onto the first clean portion.

13. The method according to claim 11, further comprising making the first clean portion, the second clean portion, or both by laser abrasion of the inner surface performed downstream of a vulcanization of the tyre.

14. The method according to claim 11, further comprising, for the purpose of making the first clean portion, the second clean portion, or both, the following steps:
producing a green tyre;
applying a first protective patch, a second protective patch, or both at a respective first portion of inner surface, a second portion of inner surface, or both precursor respectively of the first clean portion, the second clean portion, or both;
vulcanizing the green tyre; and
removing the first protective patch, the second protective patch, or both from the vulcanized tyre.

15. The method according to claim 11, further comprising marking, on the inner surface, at the first clean portion, the second clean portion, or both, a sign representative of an intersection between the inner surface and an equatorial plane of the tyre.

16. The method according to claim 11, further comprising, before fixing the second monitoring device, cleaning the second clean portion with a detergent.

17. The method according to claim 16, wherein cleaning with the detergent is performed using one or more of the following: hydrocarbon-based solvent, ketone solvent, and alcohol-based solvent.

18. The method according to claim 11, wherein the first clean portion is spatially separated from the second clean portion, and wherein the first clean portion, the second clean portion, or both are made at a crown portion of the tyre.

19. The method according to claim 11, wherein the tyre comprises a plurality of clean portions, including the first clean portion and the second clean portion, and wherein the clean portions of the plurality are substantially angularly uniformly distributed along the inner surface of the tyre.

20. A Vulcanized tyre comprising at least a first and a second clean portion of an inner surface of the tyre, wherein the tyre comprises a first monitoring device fixed onto the first clean portion, and wherein the second clean portion is free of monitoring devices.
